(19) United States
(12) Patent Application Publication
(10) Pub. No.: US 2011/0249768 A1
(43) Pub. Date: Oct. 13, 2011

(54) PEAK SUPPRESSION DEVICE AND PEAK SUPPRESSION METHOD

(76) Inventor: Toshihide Kuwabara, Tokyo (JP)

(21) Appl. No.: 13/130,948

(22) PCT Filed: Nov. 27, 2009
(86) PCT No.: PCT/JP2009/070032

§ 371 Date: Jun. 21, 2011

(30) Foreign Application Priority Data
Nov. 28, 2008 (JP) 2008-304165

(51) Int. Cl. H04L 27/00; G06G 7/16

(52) U.S. Cl. 375/295; 327/356

(57) ABSTRACT

A peak suppression device includes: a peak determination unit which determines a peak value of a waveform of an input signal; an impulse signal generation unit which generates an impulse signal corresponding to a difference between the peak value and a predetermined value if an absolute value of the peak value is greater than the predetermined value; a multiplication unit which multiplies the generated impulse signal by a predetermined impulse response waveform so as to generate a peak suppression signal; and a subtraction unit which subtracts the peak suppression signal from the input signal.

### REFERENCE TO RELATED APPLICATION

The present invention is the National Phase of PCT/JP2009/070032, filed Nov. 27, 2009, which is based upon and claims the benefit of the priority of Japanese patent application No. 2008-304165 filed on Nov. 28, 2008, the disclosure of which is incorporated herein in its entirety by reference thereto.

### TECHNICAL FIELD

The present invention relates to a peak suppression device and peak suppression method, and particularly to a peak suppression technology (Crest Factor Reduction (CFR)) for a modulated wave signal for communication such as W-CDMA.

### BACKGROUND

As communication systems realizing a high-speed wireless transmission, modulation methods such as W-CDMA are widely used. In these modulation methods, high peak power occurs, and this is a disadvantage for the power utilization efficiency of a transmission amplifier. Therefore, a clipping process that suppresses peak power is often performed. In this case, since the clipping process causes spurious emissions outside the bandwidth, a process that suppresses the spurious is performed.

For instance, in Patent Document 1, there are provided a reference filter for band-limiting an input signal, an amplitude control unit for outputting an impulse signal having an amplitude proportionate to an excess portion when an amplitude component of an output signal from the reference filter exceeds a set value, and a subtractor for subtracting the output signal of the amplitude control unit from a delayed input signal. Spurious emissions are suppressed by connecting an output of a band-limiting filter to an output of the subtractor.

Further, in Patent Document 2, a peak suppression signal is generated by multiplying an input signal by a peak suppression ratio. Since this process is basically nonlinear, it causes deterioration of the spectrum. Therefore, the signal needs to go through a filter in order to suppress spurious emissions after the process.

### [Patent Document 1]

Japanese Patent Kokai Publication No. JP-P2004-179813A

### [Patent Document 2]

Japanese Patent Kokai Publication No. JP-P2008-047959A

### SUMMARY

The disclosures of Patent Documents 1 and 2 are incorporated herein in their entirety by reference thereto. The following analysis is given by the present invention.

In a conventional clipping process (peak suppression process), a filter is provided in order to suppress spurious emissions outside the bandwidth. This may influence the original input signal and deterioration of an EVM (Error Vector Magnitude) may occur. If it is attempted to create a steep filter in order to avoid influence on the original input signal, the circuit size may increase.

It is an object of the present invention to provide a peak suppression device and peak suppression method capable of suppressing an increase in circuit size.

According to an aspect of the present invention, there is provided a peak suppression device comprising: a peak determination unit that determines a peak value of a waveform of an input signal, an impulse signal generation unit that generates an impulse signal corresponding to a difference between the peak value and a predetermined value if an absolute value of the peak value is greater than the predetermined value, a multiplication unit that multiplies the generated impulse signal by a predetermined impulse response waveform so as to generate a peak suppression signal, and a subtraction unit that subtracts the peak suppression signal from the input signal.

According to another aspect of the present invention, there is provided a peak suppression method comprising: determining a peak value of a waveform of an input signal, generating an impulse signal corresponding to a difference between the peak value and a predetermined value if an absolute value of the peak value is greater than the predetermined value, multiplying the generated impulse signal by a predetermined impulse response waveform so as to generate a peak suppression signal, and subtracting the peak suppression signal from the input signal.

According to the present invention, an increase in circuit size can be suppressed.

### BRIEF DESCRIPTION OF THE DRAWINGS

FIG. 1 is a drawing showing a configuration of an RF transmitter for base station relating to an exemplary embodiment of the present invention.

FIG. 2 is a drawing showing a configuration of a peak suppression device relating to the exemplary embodiment of the present invention.

FIG. 3 is a block diagram showing the configuration of a peak suppression device relating to a first example of the present invention.

FIG. 4 is a block diagram showing the configuration of a coefficient setting unit relating to the first example of the present invention.

FIG. 5 is a drawing showing a bandwidth corresponding to a first coefficient group.

FIG. 6 is a drawing showing an impulse response waveform corresponding to the first coefficient group.

FIG. 7 is a drawing showing a bandwidth corresponding to a second coefficient group.

FIG. 8 is a drawing showing an impulse response waveform corresponding to the second coefficient group.

FIG. 9 is a drawing showing a bandwidth corresponding to a third coefficient group.

FIG. 10 is a drawing showing an impulse response waveform corresponding to the third coefficient group.

FIG. 11 is a drawing showing a bandwidth corresponding to a fourth coefficient group.

FIG. 12 is a drawing showing an impulse response waveform corresponding to the fourth coefficient group.

FIG. 13 is a drawing showing frequency responses of the four impulse response waveforms.

FIG. 14 is a block diagram showing a configuration of a peak suppression device relating to a second example of the present invention.

### MODES FOR CARRYING OUT THE INVENTION

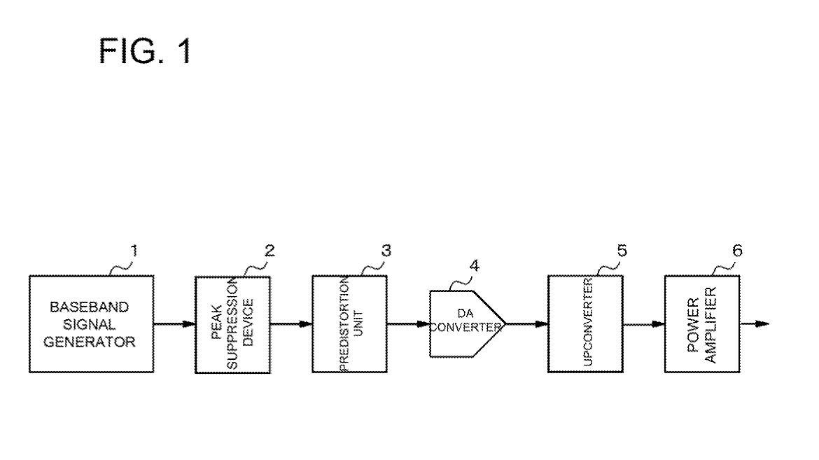

FIG. 1 is a drawing showing the configuration of an RF transmitter for base station relating to an exemplary embodiment of the present invention. The RF transmitter for base station comprises a baseband signal generator 1, a peak suppression device 2, a predistortion unit 3, a DA converter 4, an upconverter 5, and a power amplifier 6.

The baseband signal generator 1 outputs a modulated wave signal, which is a baseband signal, for communication such as W-CDMA to the peak suppression device 2. The peak suppression device 2 suppresses a peak of a waveform of the modulated wave signal for communication. The predistortion unit 3 generates a signal having characteristics opposite to an amplifier distortion by digital signal processing, linearizing the signal having its peak suppressed, and outputs the result to the DA converter 4. The DA converter 4 converts the linearized signal into an analog signal. The upconverter upconverts the analog signal into an RF signal. The power amplifier 6 amplifies the upconverted signal and outputs it externally as a wireless signal.

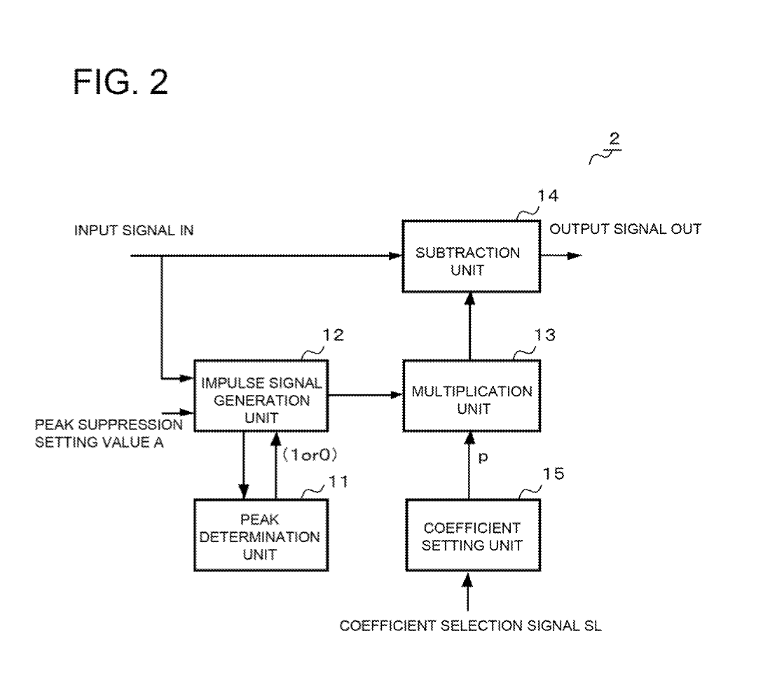

FIG. 2 is a drawing showing the configuration of the peak suppression device relating to the exemplary embodiment of the present invention. The peak suppression device 2 comprises a peak determination unit 11 that determines a peak value of a waveform of an input signal IN, an impulse signal generation unit 12 that generates an impulse signal corresponding to a difference between the peak value and a predetermined value if the absolute value of the peak value is greater than the predetermined value (peak suppression setting value A), a multiplication unit 13 that multiplies the generated impulse signal by a predetermined impulse response waveform so as to generate a peak suppression signal, and a subtraction unit 14 that subtracts the peak suppression signal from the input signal. The subtraction unit 14 outputs the subtraction result as an output signal OUT.

Further, it is preferable that the peak determination unit 11 determine the maximum absolute value of the waveform of the input signal within a predetermined period of time as the peak value.

Further, it is preferable that the predetermined impulse response waveform have a set of coefficients corresponding to a bandwidth of the input signal. These coefficients are constituted by a plurality of sets, each set corresponding to each of a plurality of bandwidths of the input signal, and one of the sets can be selected externally. In other words, the peak suppression device 2 comprises a coefficient setting unit 15, which selects an impulse response waveform having coefficients corresponding to the bandwidth of the input signal based on a coefficient selection signal (tap select signal) SL and gives the selected impulse response waveform to the multiplication unit 13. As described, the impulse response waveforms, which will serve as the peak suppression signal waveforms, stored in memory are used. The peak suppression signal is calculated by multiplying the peak suppression signal waveform by a fixed value calculated from the difference between the peak suppression setting value A and the peak signal of the waveform of the input signal IN. Since the peak suppression signal is band-limited, it is not necessary to filter it again. In other words, a band-limiting filter is not needed; therefore the circuit size can be suppressed.

According to the conventional technology, for instance, in a case where a spectrum outside the bandwidth is included in a waveform having its peak suppressed once, the peak may be reproduced when the waveform having its peak suppressed passes through a band-limiting filter. If a waveform is smoothed by a filter after its form is changed in order to suppress its peak, the peak part may be reproduced. Meanwhile, in the peak suppression device 2 of the present invention, a peak is suppressed to a target value unless peaks occur consecutively. As a result, the configuration of the device can be simplified because it does not need a multi-stage configuration in order to suppress a peak to a target value.

As described, the peak suppression device 2 of the present invention solves the conventional problems because a complex filter is not needed and a peak can be suppressed almost to a setting value.

### Example 1

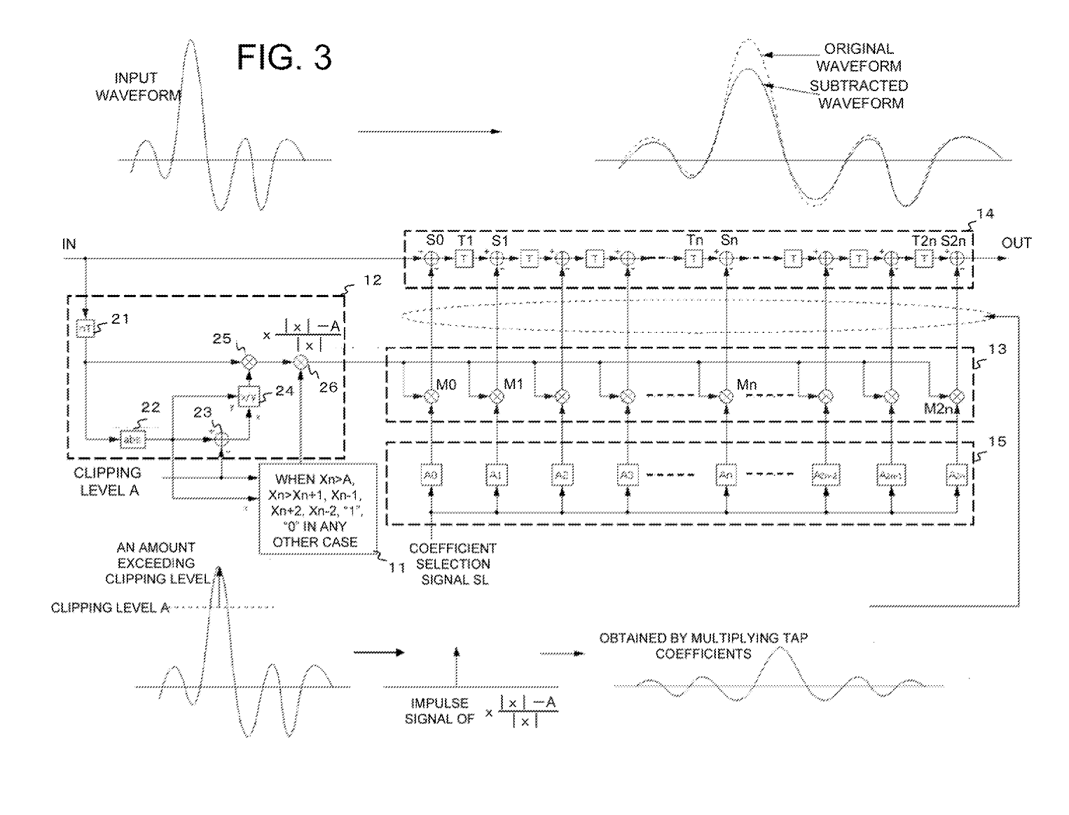

FIG. 3 is a block diagram showing the configuration of a peak suppression device relating to a first example of the present invention. In FIG. 3, symbols same as those in FIG. 2 denote the same things.

The peak determination unit 11 receives complex signal data, the input signal IN (value xn), via a delay circuit 21 and an absolute value circuit 22 in the impulse signal generation unit 12, and compares the data to a set clipping level A. More concretely, the peak determination unit 11 outputs “1” when the input signal xn is greater than signals before and after in time, xn−1, xn−2, xn+1, and xn+2, and than the clipping level A (peak suppression setting value A), and outputs “0” in any other case. Here, the input signal is compared with two signals before and after, however, the comparison targets are not limited thereto and may be waveforms within a predetermined period of time.

The impulse signal generation unit 12 comprises the delay circuit 21, the absolute value circuit 22, a subtractor 23, a divider 24, and multipliers 25 and 26. The delay circuit 21 delays the input signal IN and outputs the result to the absolute value circuit 22 and the multiplier 25. The absolute value circuit 22 derives the absolute value of the value outputted by the delay circuit 21 and outputs the result to the subtractor 23, the divider 24, and the peak determination unit 11. The subtractor 23 subtracts the clipping level A from the output of the absolute value circuit 22 and outputs the subtraction result to the divider 24. The divider 24 divides the output of the subtractor 23 by the output of the absolute value circuit 22 and outputs the division result to the multiplier 25.

In the circuit configuration described above, the multiplier 25 performs a calculation xn·(|xn|−A)/|xn| for the input signal IN (value xn). The multiplier 26 multiplies the division result of the multiplier 25 by the output of the peak determination unit 11 and generates an impulse signal at the position of a peak of the original complex signal. The generated impulse signal has an amplitude exceeding that of the clipping level A and the same phase as that of the original peak signal.

The multiplication unit 13 performs a complex multiplication of the impulse signal outputted from the impulse signal generation unit 12 by outputs of tap coefficient units A0 to A2n, represented by complex numbers, using multipliers M0 to M2n, respectively. Each tap coefficient can be selected by the selector signal SL and any combination can be created.

After the tap coefficients have been multiplied, the subtraction unit 14 generates a waveform by juxtaposing signals in a time sequence and subtracts the generated waveform from the waveform of the original input signal IN. More concretely, the input signal IN is passed through flip-flops T1 to T2n (delay line) and subtractors S0 to S2n are provided at each input end of the flip-flops T1 to T2n and at an output end of the flip-flop T2n. The subtractors S0 to S2n subtract the signal (impulse response signal), the result of the tap coefficient multiplication, from the input signal IN and output signals of the flip-flops T1 to T2n, respectively. At this time, the overall delay is adjusted so that the timing of the signal multiplied by the output of the tap coefficient unit An in the center of the tap coefficients coincides with that of the peak of the input signal IN, i.e., so that the subtractor Sn performs the subtraction on that signal. More concretely, the delay time of the delay circuit 21 is set so as to correspond to the delay time of the flip-flops T1 to Tn.

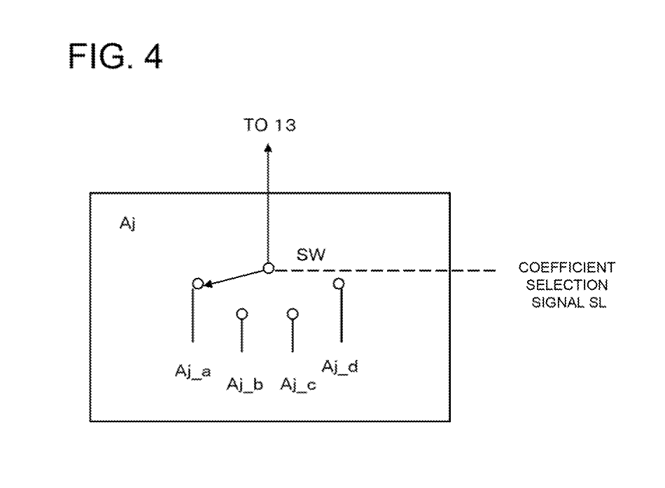

Next, the tap coefficient units Aj (j=0 to 2n) will be described. As shown in FIG. 4, four kinds of tap coefficients are prepared in the coefficient setting unit 15 so as to be able to support a four-wave composite signal and the coefficients are selected by a switch SW operated by the coefficient selection signal SL. The four kinds of tap coefficients Aj_a, Aj_b, Aj_c, and Aj_d (j=0 to 2n) correspond to impulse response signals band-limited so as to stay within each of four bands. The tap outputs selected by the switch SW are composed and the outputs are further normalized so that a median (the maximum value) of the tap coefficients will be “1”.

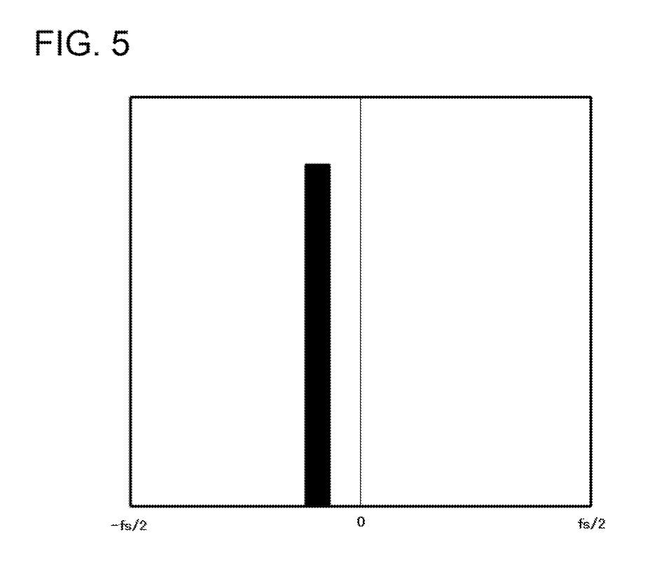

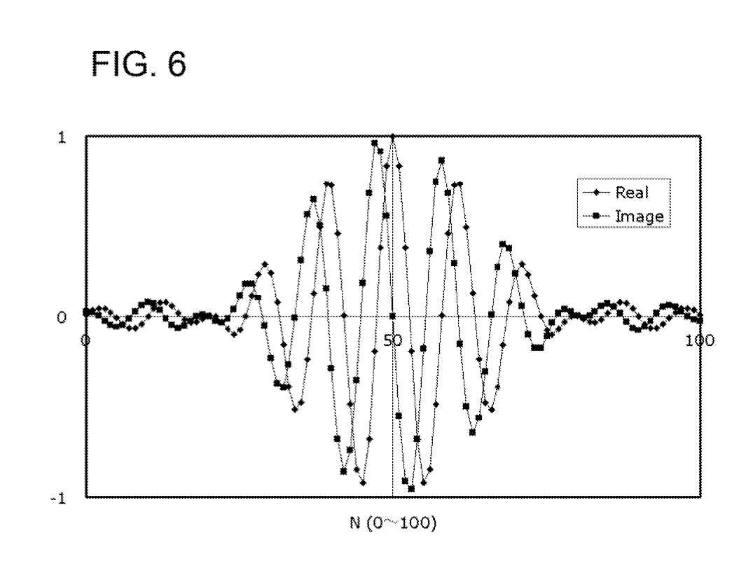

The tap coefficients Aj_a correspond to an impulse signal band-limited to a bandwidth shown in FIG. 5. More concretely, the tap coefficients Aj_a are obtained by multiplying a waveform obtained by subjecting the bandwidth shown in FIG. 5 to inverse-FFT processing in a frequency domain by an appropriate window function, and correspond to each point of an impulse response waveform shown in FIG. 6. Further, fs is a sampling frequency.

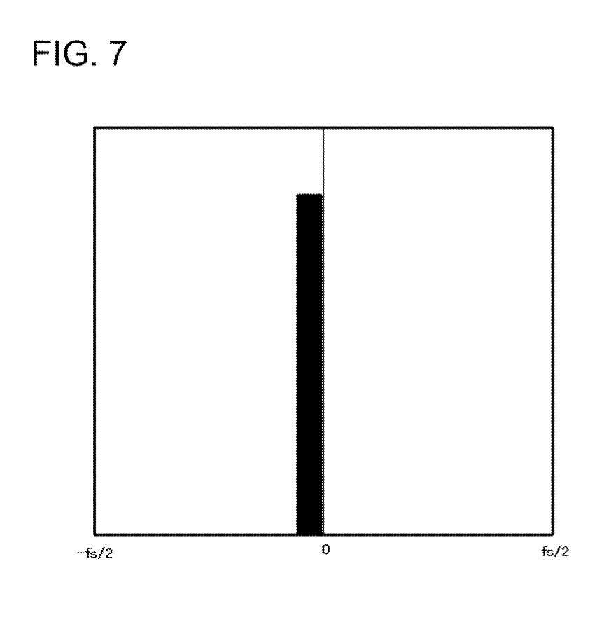

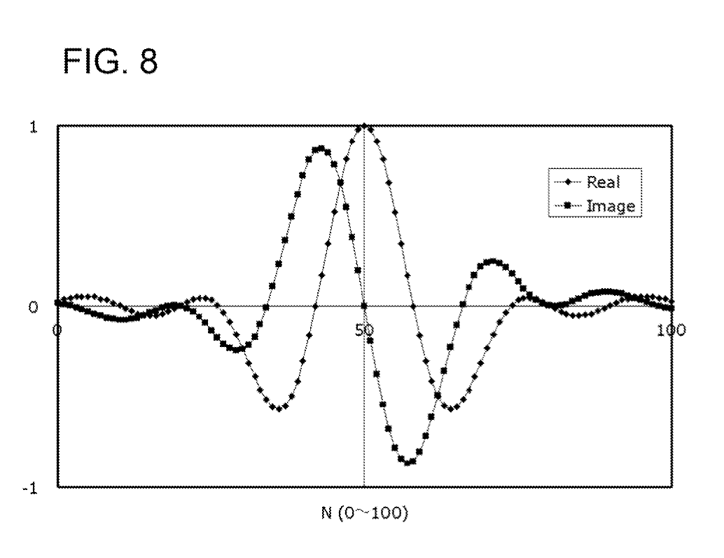

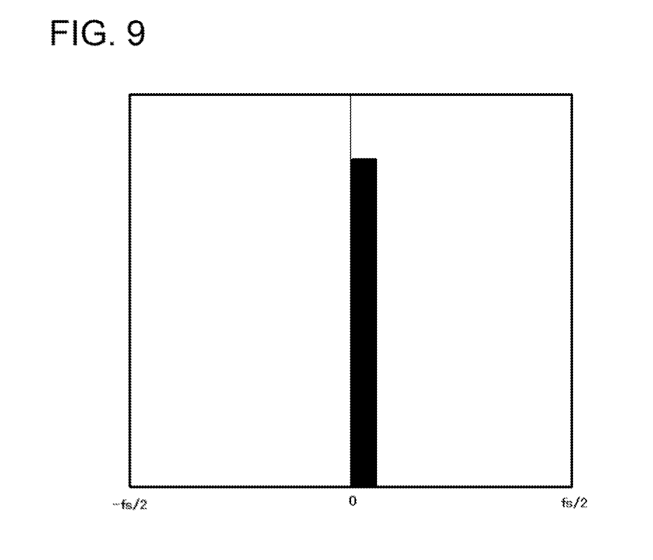

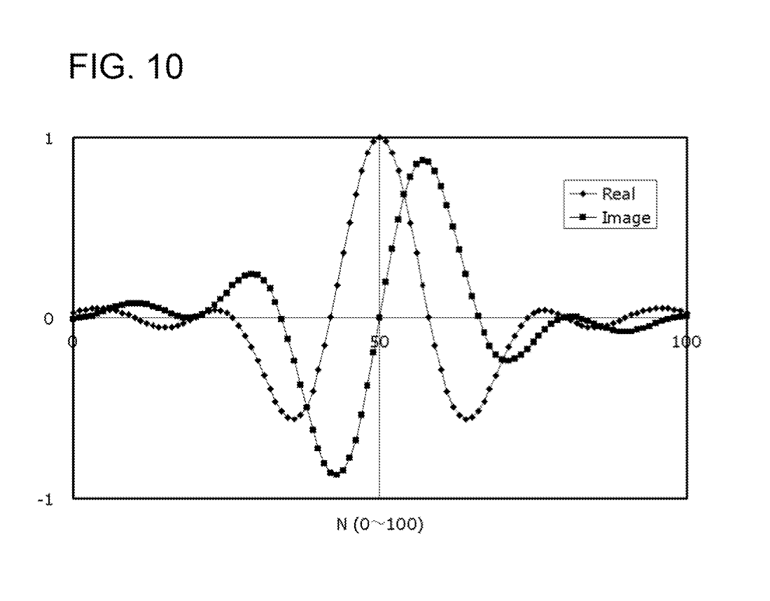

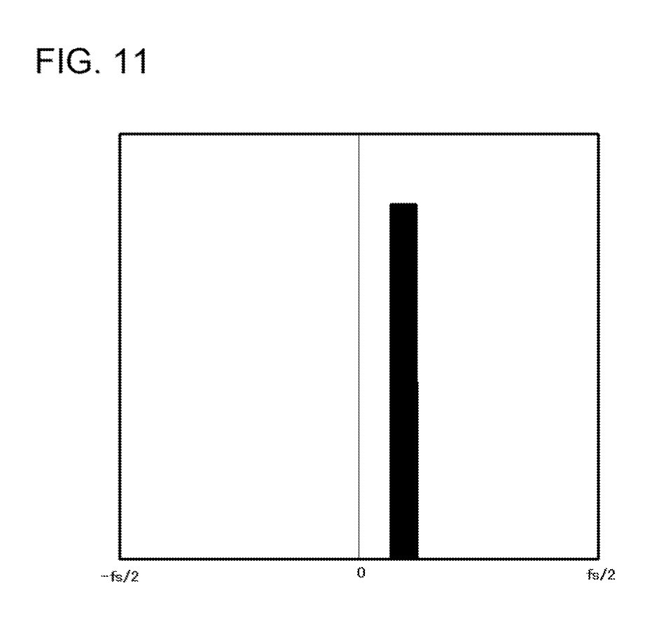

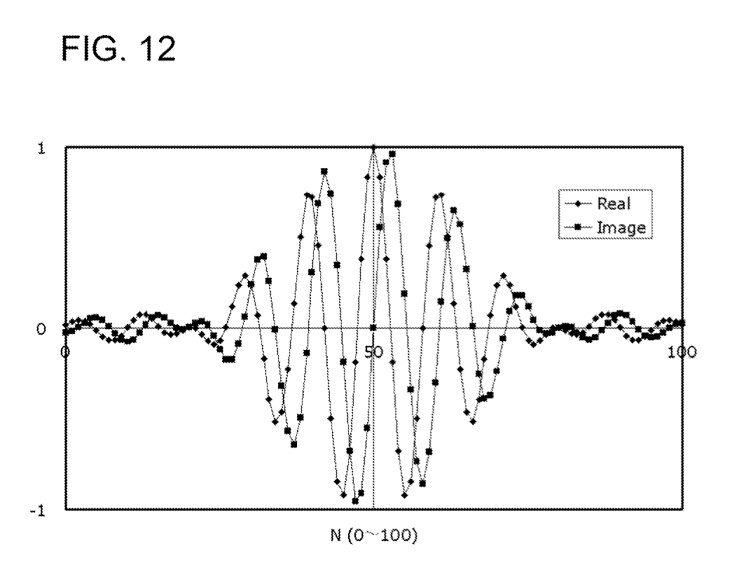

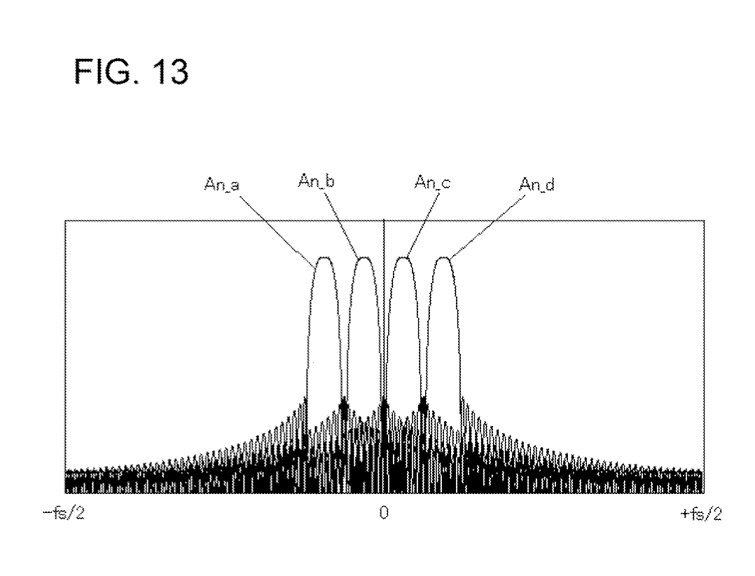

Similarly, the tap coefficients Aj_b correspond to an impulse band-limited to a bandwidth shown in FIG. 7 and to each point of an impulse response waveform shown in FIG. 8. Further, the tap coefficients Aj_c correspond to an impulse band-limited to a bandwidth shown in FIG. 9 and to each point of an impulse response waveform shown in FIG. 10. Further, the tap coefficients Aj_d correspond to an impulse band-limited to a bandwidth shown in FIG. 11 and to each point of an impulse response waveform shown in FIG. 12. Each waveform is normalized so that the center of the tap coefficients is “1”. Frequency responses obtained by subjecting these signals to FFT processing have a wider bandwidth due to the influence of the window function and are as shown in FIG. 13.

Since the peak suppression device of the present example performs peak suppression by subtracting the impulse response signal generated by the multiplication unit 13 from the original input signal IN, the occurrence of an unnecessary signal outside the bandwidth caused by the peak suppression is inhibited. The signal for peak suppression is generated by first creating an impulse signal of x·(|x|−A)/|x| (where x is the amplitude of the original input signal IN) and generating an impulse response signal by multiplying the impulse signal by the tap coefficients. The generated impulse response signal has an amplitude exceeding that of the clipping level A and the same phase as that of the original peak signal. Therefore, by multiplying the impulse signal by the tap coefficients and subtracting the result from the original signal, the amplitude of the output signal OUT is decreased and becomes equal to the clipping level A at the peak since the median of the tap coefficients is “1”.

### Example 2

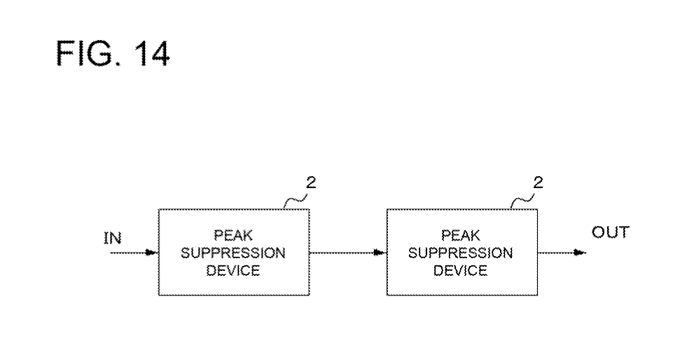

FIG. 14 is a block diagram showing the configuration of a peak suppression device relating to a second example of the present invention. In FIG. 14, two peak suppression devices shown in FIG. 2 are connected in series and the processing is repeated. In the peak suppression device shown in FIG. 2, when the signal generated for peak suppression is subtracted from the original input signal IN, the amplitudes of signals before and after may conversely increase depending on the waveform of the input signal IN and a new peak may occur. Meanwhile, by connecting a plurality of the peak suppression devices in series, the peak suppression effects become even more reliable.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

### EXPLANATIONS OF SYMBOLS

1: baseband signal generator
2: peak suppression device
3: predistortion unit
4: DA converter
5: upconverter
6: power amplifier
11: peak determination unit
12: impulse signal generation unit
13: multiplication unit
14: subtraction unit
15: coefficient setting unit
21: delay circuit
22: absolute value circuit
23, S0 to S2n: subtractor
24: divider
25, 26, M0 to M2n: multiplier
A0 to A2n: tap coefficient unit
SW: switch
T1 to T2n: flip-flop

What is claimed is:

1. A peak suppression device comprising:
a peak determination unit that determines a peak value of a waveform of an input signal;
an impulse signal generation unit that generates an impulse signal corresponding to a difference between said peak value and a predetermined value if an absolute value of said peak value is greater than said predetermined value;
a multiplication unit that multiplies said generated impulse signal by a predetermined impulse response waveform so as to generate a peak suppression signal; and
a subtraction unit that subtracts said peak suppression signal from said input signal.

2. The peak suppression device as defined in claim 1, wherein said peak determination unit determines a maximum absolute value of the waveform of said input signal within a predetermined period of time as said peak value.

3. The peak suppression device as defined in claim 1, wherein said predetermined impulse response waveform has a set of coefficients corresponding to a bandwidth of said input signal.

4. The peak suppression device as defined in claim 3, wherein said coefficients are constituted by a plurality of sets, each set corresponding to each of a plurality of bandwidths of said input signal and one of the sets can be selected externally.

5. A peak suppression device having a plurality of the peak suppression devices as defined in claim 1 connected in series.

6. A transmitter comprising the peak suppression device as defined in claim 1.

7. A peak suppression method, comprising:
determining a peak value of a waveform of an input signal;
generating an impulse signal corresponding to a difference between said peak value and a predetermined value if an absolute value of said peak value is greater than said predetermined value;
multiplying said generated impulse signal by a predetermined impulse response waveform so as to generate a peak suppression signal; and
subtracting said peak suppression signal from said input signal.

8. The peak suppression method as defined in claim 7, wherein said determining said peak value is to determine a maximum absolute value of the waveform of said input signal within a predetermined period of time as said peak value.

9. The peak suppression method as defined in claim 7, wherein said predetermined impulse response waveform has a set of coefficients corresponding to a bandwidth of said input signal.

10. The peak suppression method as defined in claim 9, wherein said coefficients are constituted by a plurality of sets, each set corresponding to each of a plurality of bandwidths of said input signal and one of the sets can be selected externally.
